(19) United States
(12) Patent Application Publication
(10) Pub. No.: US 2026/0120685 A1
(43) Pub. Date: Apr. 30, 2026

(54) Large-Scale Context Retrieval for Automatic Speech Recognition

(71) Applicant: Google LLC, Mountain View, CA (US)

(72) Inventors: Zhiqi Huang, Mountain View, CA (US); Diamantino Antonio Caseiro, Philadelphia, PA (US); Christopher Li, Jersey City, NJ (US); Zelin Wu, Jersey City, NJ (US); Patrick Maxim Rondon, New York, NY (US); Kandarp Joshi, New York, NY (US); Petr Zadrazil, San Mateo, CA (US); Lillian Qiaohui Zhou, Mountain View, CA (US); Petar Aleksic, Jersey City, NJ (US)

(73) Assignee: Google LLC, Mountain View, CA (US)

(21) Appl. No.: 18/933,552

(22) Filed: Oct. 31, 2024

(51) Int. Cl. G10L 15/16; G10L 15/02; G10L 15/26

(52) U.S. Cl. CPC G10L 15/16; G10L 15/02; G10L 15/26

(57) ABSTRACT

A method includes obtaining a sequence of audio embeddings derived from speech features characterizing a spoken prompt. The method also includes, for each candidate biasing phrase in a candidate phrase corpus: obtaining a phrase embedding; obtaining a sequence of wordpiece embeddings, and generating, using a scoring function, a ranking score that indicates a relevance of the phrase embedding to the sequence of audio embeddings. Based on the ranking scores generated for the candidate biasing phrases in the candidate phrase corpus, the method includes identifying the top-K biasing phrases from the candidate phrase corpus and processing, using a biaser module, the sequence of audio embeddings and the sequences of wordpiece embeddings obtained for the top-K biasing phrases to generate a context vector. The method also includes generating, using a speech recognizer, a transcription of the spoken prompt based on the context vector and the speech features characterizing the spoken prompt.

### TECHNICAL FIELD

This disclosure relates to large-scale context retrieval for automatic speech recognition.

### BACKGROUND

In automatic speech recognition (ASR), incorporating a user's context can produce more accurate transcriptions. For instance, a given audio sample may result in multiple different possible transcriptions or the correct transcription may include a rare entity or have an unusual spelling. By incorporating contextual information about a given user, the transcription quality produced by ASR models can improve. However, large volumes of contextual information are often difficult to apply during ASR.

### SUMMARY

One aspect of the disclosure provides a computer-implemented method that when executed on data processing hardware causes the data processing hardware to perform operations that include obtaining a sequence of audio embeddings derived from speech features characterizing a spoken prompt. The operations also include, for each candidate biasing phrase in a candidate phrase corpus: obtaining a corresponding phrase embedding, obtaining a corresponding sequence of wordpiece embeddings, and generating, using a scoring function, a corresponding ranking score that indicates a relevance of the corresponding phrase embedding to the sequence of audio embeddings. Based on the corresponding ranking scores generated for the candidate biasing phrases in the candidate phrase corpus, the operations also include identifying the top-K biasing phrases from the candidate phrase corpus and processing, using a biaser module, the sequence of audio embeddings and the corresponding sequences of wordpiece embeddings obtained for the top-K biasing phrases to generate a context vector. The operations further include generating, using a speech recognizer, a transcription of the spoken prompt based on the context vector and the speech features characterizing the spoken prompt.

Implementations of the disclosure may include one or more of the following optional features. In some implementations, the operations further include receiving the speech features characterizing the spoken prompt and processing, by an audio encoder, the speech features to generate a corresponding sequence of audio encodings. Here, obtaining the sequence of audio embeddings includes projecting, by a query encoder, the sequence of audio encodings into the sequence of audio embeddings. In these implementations, generating the transcription of the spoken prompt may further include combining the context vector and the sequence of audio encodings into a combined input, and processing, by a speech decoder, the combined input to generate the transcription of the spoken prompt.

In some examples, the scoring function includes a sequence level scoring function. In these examples, the sequence level scoring function may be configured to generate the corresponding ranking score by computing a mean pool of the sequence of audio embeddings to generate a single dense audio vector, computing a mean pool of the corresponding sequence of wordpiece embeddings to generate a single dense phrase vector, and generating the corresponding ranking score by computing a dot-product of the single dense audio vector and the single dense phrase vector. In some implementations, the scoring function includes a segment level scoring function. In these implementations, the segment level scoring function may be configured to generate the corresponding ranking score by separating speech features characterizing the spoken prompt into r fixed-length segments of size w, generating, by an audio encoder, the fixed-length segments into corresponding audio encodings, projecting, by a query encoder, the corresponding audio encodings into the sequence of audio embeddings, performing stack-and-pooling on the sequence of audio embeddings, computing a mean pool of the corresponding sequence of wordpiece embeddings to generate a single dense phrase vector, and generating the corresponding ranking score by computing a maximum segment-phrase similarity between the single sense phrase vector and the stacked-and-pooled sequence of audio embeddings.

In some examples, the neural retrieval module, the biaser module, and the speech recognizer form a retrieval-augmented Neural Associative Memory (NAM) Automatic Speech Recognition (ASR) model that is trained end-to-end by a multi-task training process. In these examples, the multi-task training process may train the retrieval-augmented NAM ASR model on a biasing phrase retrieval task based on a contrastive loss function and a speech recognition task based on an ASR loss function. Additionally or alternatively, the retrieval-augmented NAM ASR model includes an audio encoder that is shared by the neural retrieval module and the speech recognizer.

Another aspect of the disclosure provides a system including data processing hardware and memory hardware in communication with the data processing hardware. The memory hardware stores instructions that when executed by the data processing hardware cause the data processing hardware to perform operations that include obtaining a sequence of audio embeddings derived from speech features characterizing a spoken prompt. The operations also include, for each candidate biasing phrase in a candidate phrase corpus: obtaining a corresponding phrase embedding, obtaining a corresponding sequence of wordpiece embeddings, and generating, using a scoring function, a corresponding ranking score that indicates a relevance of the corresponding phrase embedding to the sequence of audio embeddings. Based on the corresponding ranking scores generated for the candidate biasing phrases in the candidate phrase corpus, the operations also include identifying the top-K biasing phrases from the candidate phrase corpus and processing, using a biaser module, the sequence of audio embeddings and the corresponding sequences of wordpiece embeddings obtained for the top-K biasing phrases to generate a context vector. The operations further include generating, using a speech recognizer, a transcription of the spoken prompt based on the context vector and the speech features characterizing the spoken prompt.

This aspect may include one or more of the following optional features. In some implementations, the operations further include receiving the speech features characterizing the spoken prompt and processing, by an audio encoder, the speech features to generate a corresponding sequence of audio encodings. Here, obtaining the sequence of audio embeddings includes projecting, by a query encoder, the sequence of audio encodings into the sequence of audio embeddings. In these implementations, generating the transcription of the spoken prompt may further include combining the context vector and the sequence of audio encodings into a combined input, and processing, by a speech decoder, the combined input to generate the transcription of the spoken prompt.

In some examples, the scoring function includes a sequence level scoring function. In these examples, the sequence level scoring function may be configured to generate the corresponding ranking score by computing a mean pool of the sequence of audio embeddings to generate a single dense audio vector, computing a mean pool of the corresponding sequence of wordpiece embeddings to generate a single dense phrase vector, and generating the corresponding ranking score by computing a dot-product of the single dense audio vector and the single dense phrase vector. In some implementations, the scoring function includes a segment level scoring function. In these implementations, the segment level scoring function may be configured to generate the corresponding ranking score by separating speech features characterizing the spoken prompt into r fixed-length segments of size w, generating, by an audio encoder, the fixed-length segments into corresponding audio encodings, projecting, by a query encoder, the corresponding audio encodings into the sequence of audio embeddings, performing stack-and-pooling on the sequence of audio embeddings, computing a mean pool of the corresponding sequence of wordpiece embeddings to generate a single dense phrase vector, and generating the corresponding ranking score by computing a maximum segment-phrase similarity between the single sense phrase vector and the stacked-and-pooled sequence of audio embeddings.

In some examples, the neural retrieval module, the biaser module, and the speech recognizer form a retrieval-augmented Neural Associative Memory (NAM) Automatic Speech Recognition (ASR) model that is trained end-to-end by a multi-task training process. In these examples, the multi-task training process may train the retrieval-augmented NAM ASR model on a biasing phrase retrieval task based on a contrastive loss function and a speech recognition task based on an ASR loss function. Additionally or alternatively, the retrieval-augmented NAM ASR model includes an audio encoder that is shared by the neural retrieval module and the speech recognizer.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of a retrieval-augmented Neural Associative Memory (NAM) Automatic Speech Recognition (ASR) model for performing large-scale biasing phrase retrieval for improving speech recognition accuracy.

FIG. 2 is an example training process for training the retrieval-augmented NAM ASR model.

FIG. 3 is a schematic view of an example biasing phrase sampling routine for selecting candidate biasing phrases for training the retrieval-augmented NAM ASR model.

FIG. 4A is a schematic view of an example sequence level scoring function.

FIG. 4B is a schematic view of an example segment level scoring function.

FIG. 5 is a schematic view of an example computing device that may be used to implement the systems and methods described herein.

FIG. 6 is a flowchart of an example arrangement of operations for a method of performing large-scale biasing phrase retrieval for improving speech recognition accuracy.

Like reference symbols in the various drawings indicate like elements.

### DETAILED DESCRIPTION

End-to-end (E2E) speech recognition models combine the acoustic, pronunciation, and language models into a single neural network. A single neural network model improves simplicity and quality, and optimizes word error rate (WER). However, a challenge in E2E speech recognition models is optimizing performance on recognizing words that appear infrequently in a language and/or have unusual pronunciations relative to their spelling. While training data can include both human-transcribed voice data and text-only data, the use of large training data sets for training these E2E speech recognition models is inefficient. As the distribution of words in a language typically follow a Zipfian distribution, where a small number of words are used very frequently, and vast numbers of words are rarely used, increasing the number of training examples typically yields improvements of lower and lower magnitude.

Incorporating contextual biasing into a neural network ASR model can improve recognition for rare words and words with unusual pronunciations. For example, since a user's contacts are often stored on a smart phone, they can be used as context to help the ASR system recognize the names of contacts spoken by a user. Contextual biasing can be applied to ASR models by injecting both biasing context and pronunciation into the model. The contextually biased model retains the advantages of neural network models, including simple, unified training and implicit learning of the pronunciation of rare words. The contextually biased model incorporates knowledge of rare word pronunciation even if the words have never been present during training.

Attention-based contextual biasing techniques have proven to be very effective approaches for adding contextual information to E2E ASR models. However, existing techniques suffer from inherent scalability problems, as the attention module requires matching embeddings extracted from an utterance with all contextual phrases. As such, must production systems that add contextual information are only capable of scaling up to a few hundred or thousand phrases.

Implementations herein are directed toward a retrieval-augmented Neural Associative Memory (NAM) ASR model that efficiently retrieves and integrates biasing phrases that are most relevant to audio being transcribed for improving accuracy of speech recognition tasks. The retrieval-augmented NAM ASR model includes a neural retrieval module that is multimodal by matching audio to text. As will become apparent, the neural retrieval module uses the audio as a query and phrases mentioned in the audio as targets. As opposed to ad-hoc retrieval where a document is retrieved to fill in information needs of a query, the neural retrieval module is trained on the task to find all phrases that appear in the audio (query). That is, the retriever module initially identifies a top-K biasing phrases that are most relevant to the audio and then performs a recall-oriented retrieval task to retrieve the true biasing phrases in the top-K biasing phrases provided to a biaser module.

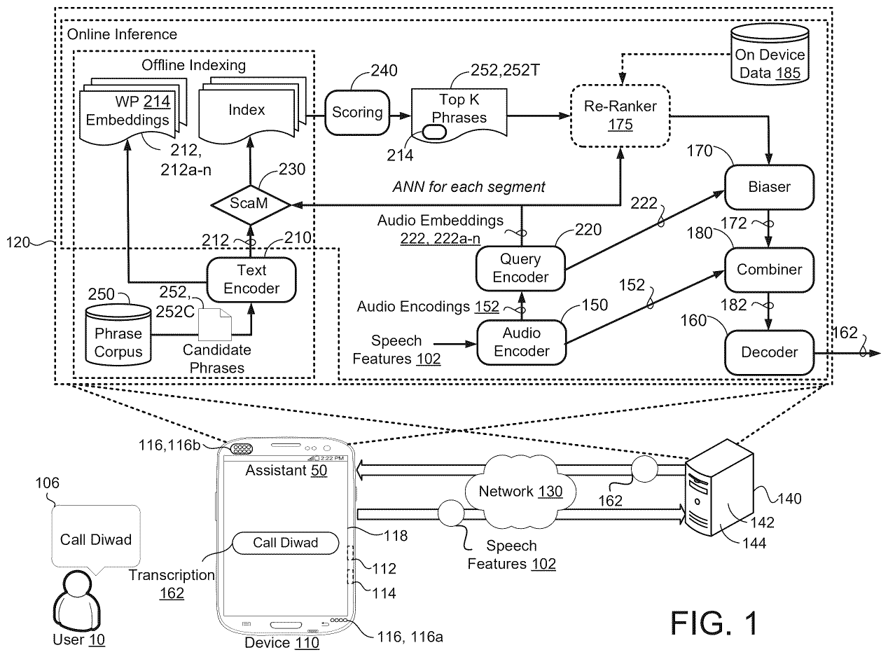

FIG. 1 illustrates an example system 100 whereby a user 10 may interact with a computing device, such as a user device 110, through voice input. The user device 110 (also referred to generally as a device 110) is configured to capture sounds (e.g., streaming audio data) from one or more users 10. Here, the streaming audio data may refer to an utterance 106 spoken by the user 10 that functions as an audible prompt/query, a command for the user device 110, or an audible communication captured by the user device 110. Speech-enabled systems of the user device 110 may field the query or command by answering the query and/or causing the command to be performed/fulfilled by one or more downstream applications. For instance, in the example shown, the user 10 interacts with a digital assistant 50 of the user device 110 that uses a spoken language model 120. The digital assistant 50 displays a digital assistant interface 118 on a screen of the user device 110 to depict a conversation between the user 10 and the digital assistant 50.

The user device 110 may correspond to any computing device associated with the user 10 and capable of receiving audio data. Some examples of user devices 110 include, but are not limited to, mobile devices (e.g., mobile phones, tablets, laptops, etc.), computers, wearable devices (e.g., smart watches), smart appliances, internet of things (IoT) devices, vehicle infotainment systems, smart displays, smart speakers, etc. The user device 110 includes data processing hardware 112 and memory hardware 114 in communication with the data processing hardware 112 and stores instructions, that when executed by the data processing hardware 112, cause the data processing hardware 112 to perform one or more operations. The user device 110 further includes an audio system 116 with an audio capture device (e.g., microphone) 116, 116a for capturing and converting the utterances 106 spoken by the user 10 into electrical signals and a speech output device (e.g., speaker) 116, 116b for communicating an audible audio signal (e.g., as output audio data from the user device 110). That is, the audio capture device 116a may convert the utterances 106 spoken by the user 10 into a sequence of speech features 102. While the user device 110 implements a single audio capture device 116a in the example shown, the user device 110 may implement an array of audio capture devices 116a without departing from the scope of the present disclosure, whereby one or more capture devices 116a in the array may not physically reside on the user device 110 but be in communication with the audio system 116.

The user device 110 communicates with a remote system 140 via a network 130. The remote system 140 may be a distributed system (e.g., cloud computing environment) having scalable elastic resources. The resources include computing resources (e.g., data processing hardware) 142 and/or storage resources (e.g., memory hardware) 144. Additionally or alternatively, the remote system 104 may be a centralized system. The network 130 may be wired, wireless, or a combination thereof, and may include private networks and/or public networks, such as the Internet.

The spoken language model 120 may execute on the user device 110, the remote system 140, or some combination thereof. The spoken language model 120 is configured to receive a respective utterance 106 spoken by the user 10, convert the respective utterance 106 into speech features 102, perform large-scale context retrieval to identify relevant biasing phrases, and perform speech recognition on the speech features 102 by incorporating the identified relevant biasing phrases for contextual biasing to improve speech recognition accuracy. Biasing phrases may also be referred to as contextual phrases or contextual biasing phrases. In some examples, the utterances 106 spoken by the user 10 correspond to spoken queries or spoken prompts. As such, utterances 106 may be interchangeably referred to as “spoken prompts 106” or “spoken queries 106” herein. Spoken prompts 106 may include any query, command, or other audible communication captured by the user device 110 (e.g., any command or query spoken by the user 10).

More specifically, the spoken language model 120 corresponds a retrieval-augmented Neural Associative Memory (NAM) automatic speech recognition (ASR) biasing model 120 that includes a neural retrieval module for identifying top-K biasing phrases 252T from a large scale corpus of phrases 250 based on input speech features 102, a biaser 170 that uses cross attention logic to compute a context vector 172 for audio inputs 222 derived from the speech features 102 and the top-K biasing phrases 252T identified by the neural retrieval module, and a speech recognizer biased by the context vector 172 for performing speech recognition on the speech features 102 to generate a corresponding transcription 162 of an underlying spoken prompt 106.

The large-scale corpus of phrases 250 may include biasing phrases obtained from various data sources. For instance, user's contacts may include names of individuals that are rare in training data and have unusual pronunciations, while calendar events in the user's calendar may indicate upcoming appointments and events with names and terms that may be relevant for the speech recognizer to recognizer. Open applications on the user device 110 and/or other devices associated with the user 10 may include biasing phrases such as place names and other navigation-related terms. Other data sources from which biasing phrases in the corpus of phrases 250 may be obtained may include a log of previously spoken commands issued by the user that may serve as historical data providing biasing phrases that the user may be likely to repeat. Additionally, media libraries associated with the user may include biasing phrases related to song/album/artist/movie names that the user may likely speak as part of a spoken prompt 106. Notably, various data sources such as contacts, calendar events, previous commands, music library may be referenced to obtain/generate biasing phrases for inclusion in the corpus of biasing phrases 250. These data sources may provide both grapheme data (e.g., written form) and phoneme data (e.g., pronunciation) for the biasing phrases. As will become apparent, by leveraging these diverse data sources to obtain the large-scale corpus of biasing phrases 250, the retrieval-augmented NAM ASR model 120 can identify/retrieve the top-K biasing phrases 252T (e.g., top-32 biasing phrases) that most likely to be included in the speech features 102 of a current spoken prompt 106 such that the biaser 170 can dynamically bias the speech recognizer to better handle rare words and unusual pronunciations to thereby improve overall speech recognition accuracy. The number of phrases in the corpus of phrases 250 may include 100 phrases, 2,000 phrases, 10,000, 25,000, 50,000, or 100,000 phrases or any other number of phrases.

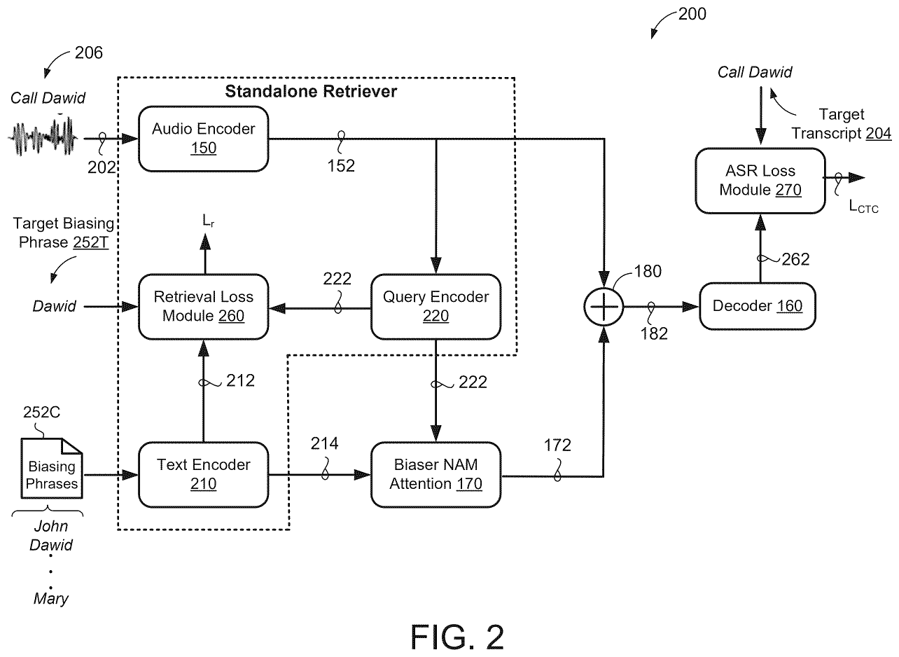

The neural retrieval module includes a dual encoder architecture implemented by a text encoder 210 and a query encoder 220 for generating speech-text embedding pairs for biasing phrase retrieval. The text encoder 210 may receive, as input, candidate biasing phrases 252, 252C from the corpus of phrases 250 and generate, as output, corresponding phrase embeddings 212, 212a-n. Each phrase embedding 212 may be paired with a corresponding sequence of wordpiece embeddings 214 associated with wordpieces that form the corresponding candidate biasing phrase 252. Notably, after the neural retrieval module is trained (see FIG. 2), the text encoder 210 is only utilized during an offline indexing to generate the phrase embeddings 212 and the wordpiece embeddings 214. Optionally, the retrieval-augmented NAM ASR biasing model 120 may incorporate a scalable matching engine 230 that is configured to index the candidate phrases 252, 252C from the corpus of candidate phrases 250 during the offline indexing by receiving the phrase embeddings 212 output by the text encoder 210 and creating an index 232 (e.g., hash map) between each candidate phrase 252C and the corresponding wordpiece embeddings 214. During online inference, the query encoder 220 is configured to project audio embeddings 222, 222a-n derived from corresponding speech features 102 so that the audio embeddings (Eₐ) 222 can be matched with the phrase embeddings 212. Initially, an audio encoder 150 may process the speech features 102 derived from the audio characterizing the spoken prompt 106 captured by the audio capture device 116a to generate corresponding audio encodings 152 and the query encoder 220 may project the audio encodings 152 into corresponding audio embeddings (Eₐ) 222. During the online inference, the audio embeddings 222 output by the query encoder 220 may query the scalable matching engine 230 to identify the top-k biasing phrases 252, 252T that best match the audio embeddings 222 associated with the current spoken prompt 106.

The audio encoder 150 may include a plurality of multi-head attention layers. For instance, the audio encoder 150 may have 300-600 million parameters and include 12 conformer layers each including eight (8) attention heads and a model dimension of 4096 and a convolution kernel size equal to five (5). The audio encoder may include other types of multi-head attention layers such as Transformer layers.

The query encoder 220 may also include a plurality of multi-head attention layers such as Conformer layers or Transformer layers. For instance, the query encoder 220 may have 48.3 million parameters and include two (2) Conformer layers. The text encoder 210 may also include a plurality of multi-head attention layers such as Transformer layers or Conformer layers. For instance, the text encoder 210 may have 29.4 million parameters and include four (4) Transformer layers each including eight (8) attention heads and model and hidden dimensions set equal to 1024.

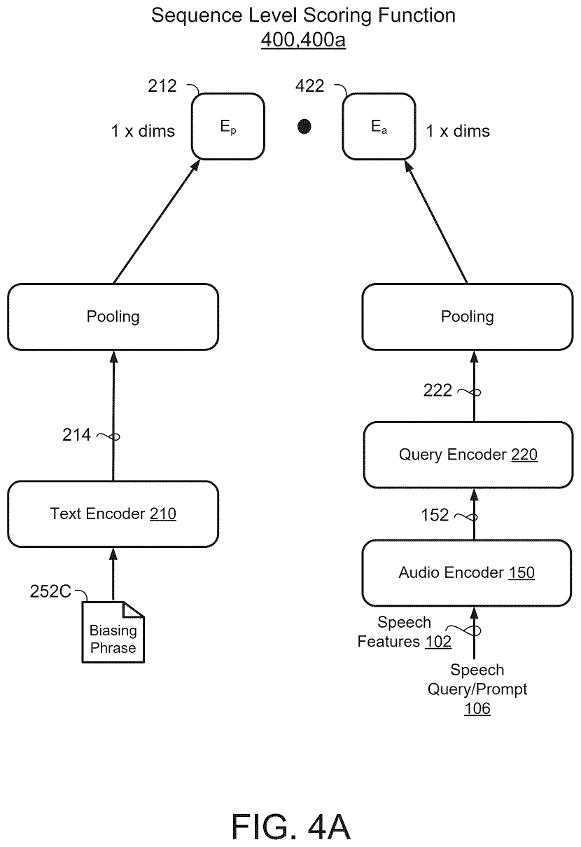

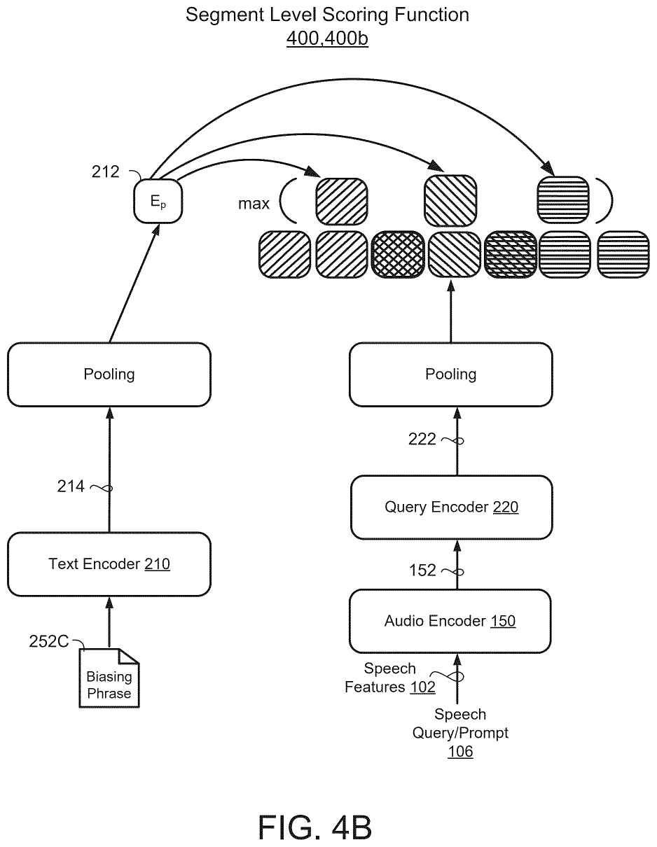

The neural retrieval module further incorporates a scoring function 400 that is configured to generate a corresponding ranking score S for each candidate phrase 252C that indicates a relevance of the candidate biasing phrase 252C to the input speech features 102. Specifically, the scoring function 400 is defined between the audio embeddings 222 projected by the query encoder 220 and the phrase embeddings 212 output by the text encoder 210 such that the neural retrieval module identifies the top-K biasing phrases 252T based on the ranking scores Because retrieving top-K biasing phrases 252T based on ranking score is equivalent to finding K nearest neighbors, the neural retrieval module can apply approximate nearest neighbors (ANN) technique to support large phrase collections. In some examples, the top-K biasing phrases 252T is equal to the top-32 biasing phrases associated with ranking scores that are most relevant to (i.e., match) the audio embeddings 222 derived from the spoken prompt 106. The scoring function 400 may provide two scoring techniques that offer different granularities of aggregation when generating ranking scores. The first scoring technique includes a sequence level scoring function 400a (FIG. 4A) and the second scoring technique includes a segment level scoring function 400b (FIG. 4B).

Referring to FIG. 4A, the sequence level scoring function 400a includes the audio encoder 150 initially encoding the speech features 102 derived from the speech prompt 106 into a corresponding sequence of audio encodings 152 and the query encoder 220 projecting the audio encodings 152 into a corresponding sequence of audio embeddings 222. A mean pool of the sequence of audio embeddings 222 may be computed to generate a single dense audio vector(Eₐ) 422. For each corresponding biasing phrase 252C, the text encoder 210 generates corresponding wordpiece embeddings 214. A mean pool of the wordpiece embeddings 212 may be computed to generate a single dense phrase vector (Eₚ) 212 that represents the corresponding biasing phrase. Optionally, a CLS token may be prefixed to the wordpiece embeddings to generate the single dense phrase vector (Eₚ) 212. Thereafter, the sequence level scoring function 400a can score the corresponding biasing phrase 252C against the single dense audio vector Eₐ 422 by computing the dot-product of the dense vectors as follows:

$${S}_{sequence} = {E}_{a} \cdot {E}_{p} \qquad [ 1 ]$$

Notably, since a candidate biasing phrase 252C will only appear in a portion of the speech features 102 characterizing the spoken prompt 106, the segment level scoring function 400b aggregates the audio into segments and locates the best segments that match the candidate biasing phrase 252C. Referring to FIG. 4B, the segment level scoring function 400b includes the audio encoder 150 initially encoding the speech features 102 derived from the speech prompt 106 into a corresponding sequence of audio encodings 152 and the query encoder 220 projecting the audio encodings 152 into a corresponding sequence of audio embeddings 222. Similar to the sequence level scoring function 400a of FIG. 4A, the text encoder 210 generates corresponding wordpiece embeddings 214 for each corresponding biasing phrase 252C and then a mean pool of the wordpiece embeddings 214 may be computed to generate a single dense phrase vector (Eₚ) 212 that represents the corresponding biasing phrase. Optionally, a CLS token may be prefixed to the wordpiece embeddings to generate the single dense phrase vector (Eₚ) 212. By contrast to the sequence level scoring function 400a shown in FIG. 4A, the segment level scoring function 400b separates the entire audio sequence into r fixed-length segments of size w, such that Eₐ [jr:jr+w]. The bracket notation [a:b] denotes the segment of audio from timestep a to timestep b. Here, w corresponds to a window size for performing stack-and-pool on the fixed-length audio frames. Thereafter. The segment level scoring function 400b computes a maximum segment-phrase similarity as follows:

$${S}_{segment} = \frac{max}{0 \leq j \leq [ \frac{T}{r} ]} {E}_{a} [ jr : jr + w ] \cdot {E}_{p} \qquad [ 2 ]$$

In some examples, the size of w may be set equal to 32 and the number of r fixed-length segments may be set equal to 16.

Notably, as opposed to retrieval techniques that apply cross-attention-based top-K phrase retrieval that perform multiple computations for multiple attention heads, the neural retrieval module provided by the retrieval-augmented NAM ASR model 120 improves retrieval efficiency by computing the dot product only once for each biasing phrase 252. Compared to the cross-attention-based top-K phrase retrieval that perform multiple computations during streaming context retrieval in a causal manner, the retrieval-augmented NAM ASR model 120 is optimized for non-streaming top-K context retrieval. As will become apparent, the training process 200 (FIG. 2) for training the neural retrieval module directly optimizes for predicting/identifying correct biasing phrases as opposed to indirectly learning retrieval though ASR loss alone.

Referring back to FIG. 1, after the neural retrieval module identifies the top-K biasing phrases 252T, the biaser 170 receives, as input, the audio embeddings 222 output by the query encoder 220 and the wordpiece embeddings 214 associated with the top-K biasing phrases 252T and generates, as output, a context vector 172. Thereafter, a combiner 180 combines the sequence of audio encodings 152 output from the audio encoder 150 and the context vector 172 output by the biaser 170 into a combined input 182. The speech recognizer includes the audio encoder 150 and a decoder 160. In some examples, the decoder 160 includes a speech decoder trained end-to-end with the audio encoder 150 on speech recognition tasks. In the example shown, the decoder 160 of the speech recognizer processes the combined input 182 of the sequence of audio encodings 152 and the context vector 172 to generate the transcription 162 to the spoken prompt 106. The retrieval-augmented NAM ASR framework 120 may provide the transcription 162 for display on the interface 118 of the user device 110.

In some additional examples, the decoder 160 is a multi-modal large language model (LLM) 160 capable of decoding speech representations derived from spoken prompts into transcriptions of the spoken prompts during a first pass. In these additional examples, the LLM 160 can perform a second pass by processing the resulting transcription 162 of the spoken prompt 106 decoded during the first pass to generate a continuation or response to the spoken prompt 106. The continuation or response may be a textual representation in a natural language and/or may include text-to-speech features (e.g., spectrograms) that may be synthesized by a synthesizer (not shown) into synthesized speech conveying the continuation or response to the spoken prompt 106. Here, the user device 110 may display the textual representation of the continuation or response on the interface 118 and/or audibly output the synthesized speech from the audio output device 116b.

In some implementations, the retrieval-augmented NAM ASR model 120 optionally incorporates a re-ranker or deferred NAM that performs on-the-fly filtering on the top-K biasing phrases 152T to select top biasing phrases with more confidence by leveraging on-device contextual data. That is, the re-ranker 175 may receive on-device data 185 for use in re-ranking the top-K biasing phrases 252T to maximize the accuracy of the biasing phrases 252 fed to the biaser 170.

While the retrieval-augmented NAM ASR model 120 depicts the neural retrieval module with a speech recognizer, the neural retrieval module may be used as a standalone neural retrieval module independently without departing from the scope of the present disclosure. For instance, the neural retrieval module may retrieve/identify the top-K biasing phrases 252T that best match audio embeddings 222 derived from speech features 102 characterizing a spoken prompt, and provide the top-K biasing phrases 252T as prior knowledge for other downstream speech systems. For example, a prompt may be structured from the top-K biasing phrases 252K and the prompt may be fed to a downstream large language model to perform generative error correction or second pass rescoring of speech recognition results generated by a separate ASR model.

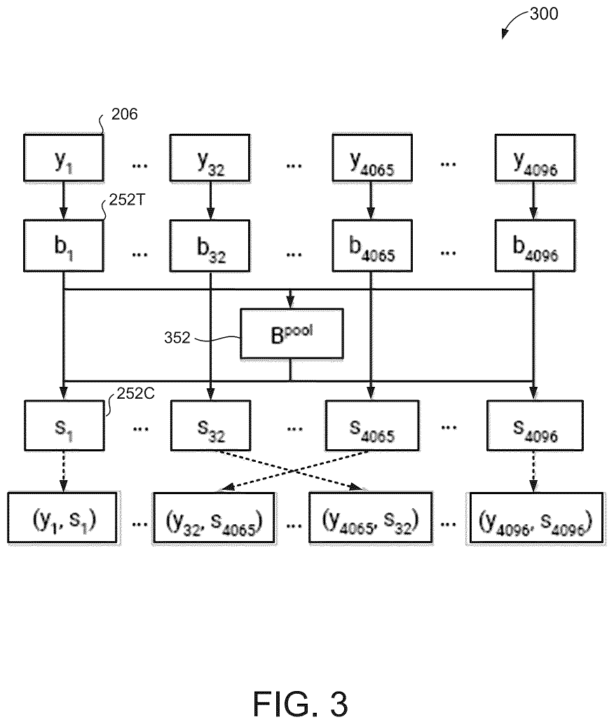

FIG. 2 provides a training process 200 for training the retrieval-augmented NAM ASR model 120. The training process 200 trains the retrieval-augmented NAM ASR model 120 on a plurality of training samples that each include training audio data 202 characterizing a corresponding training spoken utterance 206 paired with a ground-truth transcript 204 of the corresponding training spoken utterance 206, a corresponding set of candidate biasing phrases 252C sampled from a biasing phrase pool 352 (FIG. 3), and a target biasing phrase 252T that is included in both the set of candidate biasing phrases 252C and the ground-truth transcript 204. The training process 200 depicts only a single training sample. Notably, each training sample is associated with a unique set of candidate biasing phrases 252C sampled from the biasing phrase pool 352.

FIG. 3 depicts a per-training sample biasing phrase sampling routine 300 utilized by the training process 200 for sampling the unique set of candidate biasing phrases 252C from the biasing phrase pool 352 for each training sample. The corresponding training spoken utterance 206 for each training sample may be represented by yᵢ and the unique set of candidate biasing phrases 252C sampled from the biasing phrase pool (Bₚₒₒₗ) 352 may be represented by sᵢ, whereby sᵢ includes the target biasing phrase 252T represented by bi. Accordingly, each training sample may be represented by a pair (yᵢ, sᵢ) of the corresponding training spoken utterance 206 and the corresponding unique set of candidate biasing phrases 252C. In the example shown, the number of candidate biasing phrases 252C sampled from the biasing phrase pool 352 by the biasing phrase sampling routine 300 for each training sample is equal to “32” and the number of biasing phrases in the biasing phrase pool 352 is equal to “4,096”. As such, the training process 200 trains the retrieval-augmented NAM ASR model 120 on 4,096 training samples each including a corresponding unique set of 32 candidate biasing phrases 252C sampled from the biasing phrase pool 352 by the per-training sample biasing phrase sampling routine 300. The number of candidate biasing phrases sampled from the biasing phrase pool 352 may be greater than or less than to “32” without departing from the scope of the present disclosure. Similarly, the number of biasing phrases in the biasing phrase pool 352 may be greater than or less than “4,096” without departing from the scope of the present disclosure.

Referring back to FIG. 2, the text encoder 210 processes each biasing phrase 252 from the unique set of candidate biasing phrases 252C into a corresponding phrase embedding 212 and a corresponding sequence of wordpiece embeddings 214 associated with individual wordpieces that form the corresponding biasing phrase 252. Moreover, the audio encoder 150 processes the training audio data 202 characterizing the training spoken utterance 206 to generate corresponding audio encodings 152 and the query encoder 220 projects the audio encodings 152 into corresponding audio embeddings (Eₐ) 222.

A retrieval loss module 260 receives the audio embeddings 222 output from the query encoder 220 and the phrase embeddings 212 output from the text encoder 210 for all of the biasing phrase 252 from the unique set of candidate biasing phrases 252C. Notably, the phrase embedding 212 associated with the target biasing phrase 252T present in the unique set of candidate biasing phrases 252C corresponds to a positive training example while the other biasing phrases in the unique set of candidate biasing phrases 252C correspond to negative examples for computing a contrastive loss, Lr. More specifically, the retrieval loss module 260 may apply a contrastive loss function represented by the following equation:

$${L}_{r} = - \frac{1}{N} {\sum }_{1}^{N} \frac{{e}^{S ( {E}_{a , i} , {E}_{p , j} ) - m}}{{e}^{S ( {E}_{a , i} , {E}_{p , j} ) - m} + {\sum }_{j = 1 , j \neq 1}^{N} {e}^{S ( {E}_{a , i} , {E}_{p , j} )}} \qquad [ 3 ]$$

where N is the number training samples, S(E_{a,i},E_{p,j}) is the scoring function for audio embedding i and phrase embedding j, and e^{S(E}^{_{a,i}}^{,E}^{_{p,j}}^{)-m} is an additive margin softmax that extends the scoring function S by introducing margin m around each positive audio-text pair. Increasing the value of the margin m may improve recall during inference when the number of candidate biasing phrases 252C increases. Here, the margin improves a separation between the target biasing phrase 252T and the other biasing phrases 252 from the unique set of candidate biasing phrases 252C sampled for each of the N training samples. The scoring function S may include the sequence level scoring function 400a (FIG. 4A) or the segment level scoring function 400b (FIG. 4B). In some implementations, the neural retrieval module is trained individually as a standalone retriever based on the contrastive loss, Lr.

In some implementations, the training process 200 is a multi-task training process that trains the entire retrieval-augmented NAM ASR model 120 end-to-end using the contrastive loss (Eq, 3), Lr, and an ASR training loss. The ASR training loss may correspond to a Connection Temporal Classification (CTC) loss. In these implementations, the biaser 170 corresponds to a NAM attention module that receives, as input, for each of the N training samples, the audio embeddings 222 output by the query encoder 220 and the wordpiece embeddings 214 associated with the unique set of candidate biasing phrases 252C, and generates, as output, a corresponding context vector 172 for the corresponding training sample. Thereafter, the combiner 180 combines the sequence of audio encodings 152 output from the audio encoder 150 and the context vector 172 output by the biaser 170 into a corresponding combined input 182. For each training sample, the decoder 160 then processes the corresponding combined input 182 to generate a corresponding predicted transcript 262 of the corresponding training spoken utterance 206. The training process 200 includes a training loss module 270 that calculates the CTC loss (L_{CTC}) for each training sample based on the corresponding predicted transcript 262 and the corresponding ground-truth transcript 204. While the training process calculates a CTC loss, the training process 200 may calculate other types of ASR losses, such as RNN-T loss, without departing from the scope of the present disclosure.

After the multi-task training process 200 determines the contrastive loss, Lr, and the CTC loss using the retriever loss module 260 and the ASR loss module 270, respectively, the multi-task training process 200 computes a total loss, Lₜₒₜₐₗ, represented by the following equation:

$${L}_{t o t a l} = \frac{1}{2 \cdot {σ}_{C T C}^{2}} {L}_{C T C} + \frac{1}{2 \cdot {σ}_{Lr}^{2}} {L}_{r} + ln ( 4 + {σ}_{C T C}^{2} ) + ln ( 1 + {σ}_{C T C}^{2} ) \qquad [ 4 ]$$

where

$${σ}_{C T C}^{2} and {σ}_{Lr}^{2}$$

are uncertainty parameters for weighting the contribution of the contrastive loss (Lr) and the CTC loss. The multi-task training process 200 may update parameters of various components of the retrieval-augmented NAM ASR model 120 based on the total loss (Lₜₒₜₐₗ). In some scenarios, both the neural retriever module and the speech recognizer are trained from scratch via the multi-task training process 200. In other scenarios, the audio encoder 150 and the decoder 160 are pretrained and frozen during the training process, whereby only the neural retriever module and the biaser 170 are fine-tuned by the multi-task training process 200.

A software application (i.e., a software resource) may refer to computer software that causes a computing device to perform a task. In some examples, a software application may be referred to as an “application.” an “app.” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

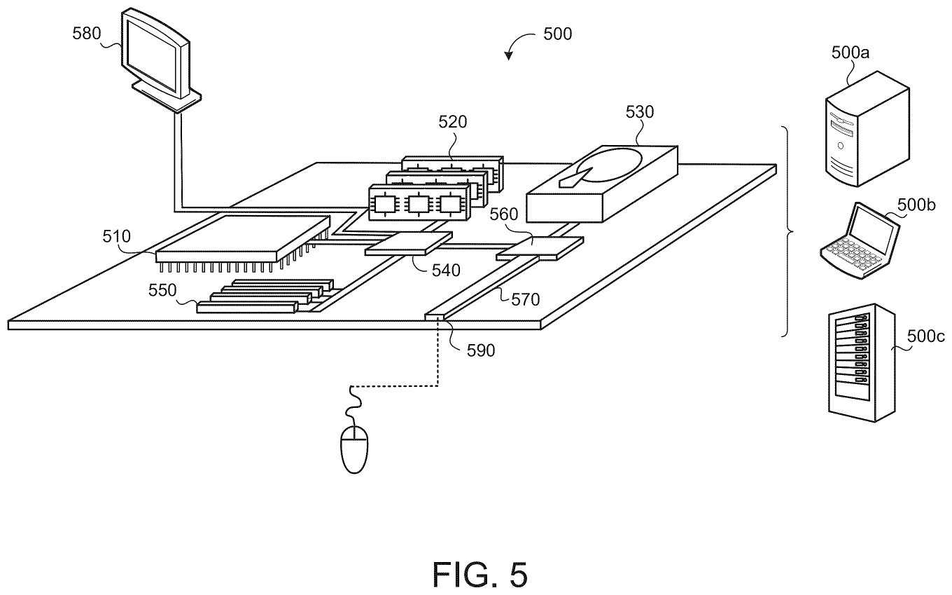

FIG. 5 is schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor (e.g., data processing hardware) 510 can process instructions for execution within the computing device 500, including instructions stored in the memory 520 or on the storage device 530 to display graphical information for a graphical user interface (GUI) on an external input/output device, such as display 580 coupled to high speed interface 540. The data processing hardware 510 may include the data processing hardware 112 of the user device 110 and/or the data processing hardware 142 of the remote system 140. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory (e.g., memory hardware) 520 stores information non-transitorily within the computing device 500. The memory hardware 520 may include the memory hardware 114 of the user device 110 and/or the memory hardware 144 of the remote system 140. The memory 520 may be a computer-readable medium, a volatile memory unit(s), or non-volatile memory unit(s) The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

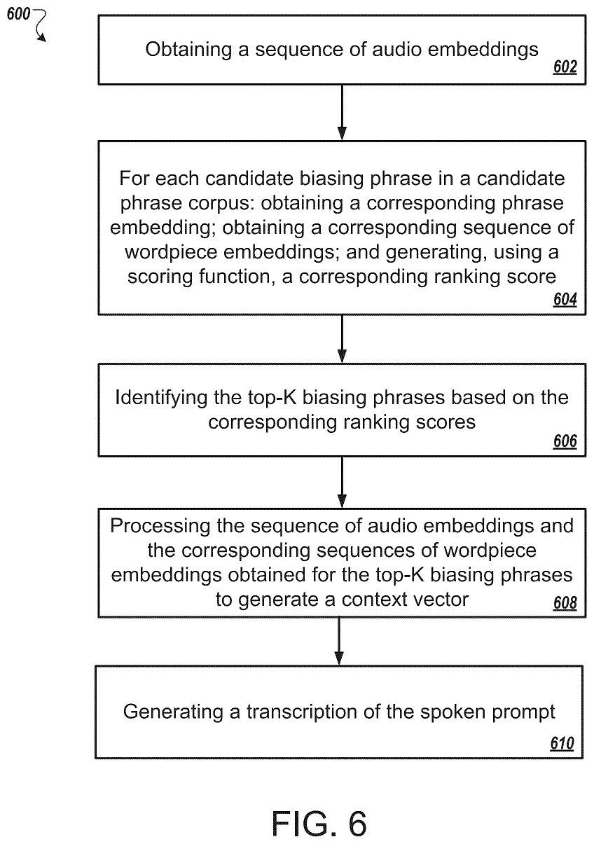

FIG. 6 is a flowchart of an example arrangement of operations for a method 600 of performing large-scale context retrieval for identifying biasing phrases 252 that appear in audio for improving automatic speech recognition (ASR) accuracy of the audio. The method 600 may execute on the data processing hardware 510 (FIG. 5) based on instructions stored on the memory hardware 520 (FIG. 5). At operation 602, the method 600 includes obtaining a sequence of audio embeddings 222 derived from speech features 104 characterizing a spoken prompt 106. At operation 604, sing a neural network retrieval module, for each candidate biasing phrase 252C in a candidate phrase corpus 250, the method 600 obtains a corresponding phrase embedding 212, obtains a corresponding sequence of wordpiece embeddings 214, and generates, using a scoring function 400, a corresponding ranking score that indicates a relevance of the corresponding phrase embedding 212 and the sequence of audio embeddings 222.

At operation 606, the method 600 includes identifying the top-K biasing phrases 252T from the candidate phrase corpus 250 based on the corresponding ranking scores generated for the candidate biasing phrases 252C in the candidate phrase corpus 250. At operation 608, the method 600 includes processing, using a biaser module 170, the sequence of audio embeddings 222 and the corresponding sequences of wordpiece embeddings 214 obtained for the top-K biasing phrases 252T to generate a context vector 172. At operation 610, the method 600 includes generating, using a speech recognizer, a transcription 162 of the spoken prompt 106 based on the context vector 172 and the speech features 102 characterizing the spoken prompt 106.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
obtaining a sequence of audio embeddings derived from speech features characterizing a spoken prompt;
using a neural retrieval module, for each candidate biasing phrase in a candidate phrase corpus:
obtaining a corresponding phrase embedding;
obtaining a corresponding sequence of wordpiece embeddings; and
generating, using a scoring function, a corresponding ranking score that indicates a relevance of the corresponding phrase embedding to the sequence of audio embeddings;
based on the corresponding ranking scores generated for the candidate biasing phrases in the candidate phrase corpus, identifying the top-K biasing phrases from the candidate phrase corpus;
processing, using a biaser module, the sequence of audio embeddings and the corresponding sequences of wordpiece embeddings obtained for the top-K biasing phrases to generate a context vector; and
generating, using a speech recognizer, a transcription of the spoken prompt based on the context vector and the speech features characterizing the spoken prompt.

2. The computer-implemented method of claim 1, wherein the operations further comprise:
receiving the speech features characterizing the spoken prompt;
processing, by an audio encoder, the speech features to generate a corresponding sequence of audio encodings,
wherein obtaining the sequence of audio embeddings comprises projecting, by a query encoder, the sequence of audio encodings into the sequence of audio embeddings.

3. The computer-implemented method of claim 2, wherein generating the transcription of the spoken prompt comprises:
combining the context vector and the sequence of audio encodings into a combined input; and
processing, by a speech decoder, the combined input to generate the transcription of the spoken prompt.

4. The computer-implemented method of claim 1, wherein the scoring function comprises a sequence level scoring function.

5. The computer-implemented method of claim 4, wherein the sequence level scoring function is configured to generate the corresponding ranking score by:
computing a mean pool of the sequence of audio embeddings to generate a single dense audio vector;
computing a mean pool of the corresponding sequence of wordpiece embeddings to generate a single dense phrase vector; and
generating the corresponding ranking score by computing a dot-product of the single dense audio vector and the single dense phrase vector.

6. The computer-implemented method of claim 1, wherein the scoring function comprises a segment level scoring function.

7. The computer-implemented method of claim 6, wherein the segment level scoring function is configured to generate the corresponding ranking score by:
separating speech features characterizing the spoken prompt into r fixed-length segments of size w;
generating, by an audio encoder, the fixed-length segments into corresponding audio encodings;
projecting, by a query encoder, the corresponding audio encodings into the sequence of audio embeddings;
performing stack-and-pooling on the sequence of audio embeddings;
computing a mean pool of the corresponding sequence of wordpiece embeddings to generate a single dense phrase vector; and
generating the corresponding ranking score by computing a maximum segment-phrase similarity between the single sense phrase vector and the stacked-and-pooled sequence of audio embeddings.

8. The computer-implemented method of claim 1, wherein the neural retrieval module, the biaser module, and the speech recognizer form a retrieval-augmented Neural Associative Memory (NAM) Automatic Speech Recognition (ASR) model that is trained end-to-end by a multi-task training process.

9. The computer-implemented method of claim 8, wherein the multi-task training process trains the retrieval-augmented NAM ASR model on a biasing phrase retrieval task based on a contrastive loss function and a speech recognition task based on an ASR loss function.

10. The computer-implemented method of claim 8, wherein the retrieval-augmented NAM ASR model comprises an audio encoder that is shared by the neural retrieval module and the speech recognizer.

11. A system comprising:
data processing hardware; and
memory hardware in communication with the data processing hardware, the memory hardware storing instructions that when executed on the data processing hardware cause the data processing hardware to perform operations comprising:
obtaining a sequence of audio embeddings derived from speech features characterizing a spoken prompt;
using a neural retrieval module, for each candidate biasing phrase in a candidate phrase corpus:
obtaining a corresponding phrase embedding;
obtaining a corresponding sequence of wordpiece embeddings; and
generating, using a scoring function, a corresponding ranking score that indicates a relevance of the corresponding phrase embedding to the sequence of audio embeddings;
based on the corresponding ranking scores generated for the candidate biasing phrases in the candidate phrase corpus, identifying the top-K biasing phrases from the candidate phrase corpus;
processing, using a biaser module, the sequence of audio embeddings and the corresponding sequences of wordpiece embeddings obtained for the top-K biasing phrases to generate a context vector; and
generating, using a speech recognizer, a transcription of the spoken prompt based on the context vector and the speech features characterizing the spoken prompt.

12. The system of claim 11, wherein the operations further comprise:
receiving the speech features characterizing the spoken prompt;
processing, by an audio encoder, the speech features to generate a corresponding sequence of audio encodings,
wherein obtaining the sequence of audio embeddings comprises projecting, by a query encoder, the sequence of audio encodings into the sequence of audio embeddings.

13. The system of claim 12, wherein generating the transcription of the spoken prompt comprises:
combining the context vector and the sequence of audio encodings into a combined input; and
processing, by a speech decoder, the combined input to generate the transcription of the spoken prompt.

14. The system of claim 11, wherein the scoring function comprises a sequence level scoring function.

15. The system of claim 14, wherein the sequence level scoring function is configured to generate the corresponding ranking score by:
computing a mean pool of the sequence of audio embeddings to generate a single dense audio vector;
computing a mean pool of the corresponding sequence of wordpiece embeddings to generate a single dense phrase vector; and
generating the corresponding ranking score by computing a dot-product of the single dense audio vector and the single dense phrase vector.

16. The system of claim 11, wherein the scoring function comprises a segment level scoring function.

17. The system of claim 16, wherein the segment level scoring function is configured to generate the corresponding ranking score by:
separating speech features characterizing the spoken prompt into r fixed-length segments of size w;
generating, by an audio encoder, the fixed-length segments into corresponding audio encodings;
projecting, by a query encoder, the corresponding audio encodings into the sequence of audio embeddings;
performing stack-and-pooling on the sequence of audio embeddings;
computing a mean pool of the corresponding sequence of wordpiece embeddings to generate a single dense phrase vector; and
generating the corresponding ranking score by computing a maximum segment-phrase similarity between the single sense phrase vector and the stacked-and-pooled sequence of audio embeddings.

18. The system of claim 11, wherein the neural retrieval module, the biaser module, and the speech recognizer form a retrieval-augmented Neural Associative Memory (NAM) Automatic Speech Recognition (ASR) model that is trained end-to-end by a multi-task training process.

19. The system of claim 18, wherein the multi-task training process trains the retrieval-augmented NAM ASR model on a biasing phrase retrieval task based on a contrastive loss function and a speech recognition task based on an ASR loss function.

20. The system of claim 18, wherein the retrieval-augmented NAM ASR model comprises an audio encoder that is shared by the neural retrieval module and the speech recognizer.
